(19) United States
(12) Patent Application Publication
(10) Pub. No.: US 2016/0247124 A1
(43) Pub. Date: Aug. 25, 2016

(54) Deferred Automatic Creation of Human Readable Meeting Placeholder Join Links Based on a Calendar Entry

(71) Applicant: Cisco Technology, Inc., San Jose, CA (US)

(72) Inventors: Magnus Aaen Holst, Kjeller (NO); Nicolai Grødum, Oslo (NO)

(21) Appl. No.: 14/629,722

(22) Filed: Feb. 24, 2015

(51) Int. Cl. G06Q 10/10; H04L 29/08; H04L 29/06

(52) U.S. Cl. CPC G06Q 10/1095; H04L 65/1096; H04L 65/1076; H04L 67/02

(57) ABSTRACT

Computer-implemented methods are performed at a user device and a server. At the user device, a meeting calendar identifier is retrieved for a previously scheduled virtual meeting. The user device sends to a server a join link request for the scheduled virtual meeting, the join link request including the meeting calendar identifier. The user device receives from the server a first join link for the scheduled virtual meeting, the first join link mapped by the server to a second join link that is used by the server to connect a user device to the scheduled virtual meeting. The second join link is generated based on the meeting calendar identifier and has more characters than the first join link. The first join link is “human readable” insofar as it includes a human readable portion that includes a string of random or non-random characters.

### TECHNICAL FIELD

The present disclosure relates to virtual meeting services.

### BACKGROUND

Today, when a meeting organizer wants participants to attend a conference with one or more meeting resources/technologies (e.g., Telepresence, web conference (e.g., WebEx® web conferencing service, etc.), the organizer needs to book (i.e., reserve/schedule) all the infrastructure and equipment resources up-front, that is, at the time the meeting is scheduled. This is currently achieved with various integration tools. These tools monitor the room and connection resources used in routing media, and then reserves all the linked resources through a management system.

### BRIEF DESCRIPTION OF THE DRAWINGS

FIG. 1 is a diagram illustrating a system in which user devices can join a virtual meeting without having to distribute join link information at the time the virtual meeting is scheduled, according to an example embodiment.

FIG. 2 is a system block diagram showing a user device and a server that form part of the system depicted in FIG. 1, according to an example embodiment.

FIG. 3 is a sequence diagram for a process by which a virtual meeting is scheduled and from which a human readable join to the virtual meeting can be generated by a user device at any time, according to an example embodiment.

FIG. 4 is a sequence diagram for a process on a user device by which a human readable join link is obtained from a server for a scheduled virtual meeting, according to an example embodiment.

FIG. 5 is a sequence diagram for a process by which a user device joins a virtual meeting using a human readable join link, according to an example embodiment.

FIG. 6 is a flow chart depicting operations performed by a user device in accordance with the process depicted in FIG. 4, according to an example embodiment.

FIGS. 7A and 7B are flow charts depicting operations performed by the server in accordance with the process depicted in FIGS. 4 and 5, according to an example embodiment.

FIGS. 8A and 8B are diagrams illustrating an example of the techniques depicted in FIGS. 1-7 for a meeting, according to an example embodiment.

### DESCRIPTION OF EXAMPLE EMBODIMENTS

### Overview

In accordance with one embodiment, a computer-implemented method is performed at a user device capable of scheduling a meeting with a calendar application or receiving an invitation to a meeting. The method includes retrieving a meeting calendar identifier for a previously scheduled virtual meeting; sending to a server a join link request for the scheduled virtual meeting, the join link request including the meeting calendar identifier; receiving from the server a first join link for the scheduled virtual meeting, the first join link mapped by the server to a second join link that is used by the server to connect a user device to the scheduled virtual meeting, the second join link having been generated based on the meeting calendar identifier and having more characters than the first join link; and storing the first join link.

In accordance with another embodiment, a computer-implemented method is provided comprising: receiving from a user device a join link request for a previously scheduled virtual meeting, the join link request including a meeting calendar identifier for the scheduled virtual meeting; generating a first join link and a second join link for the scheduled virtual meeting, the second join link being generated based on the meeting calendar identifier and having more characters than the first join link; storing data that maps the first join link to the second join link for the scheduled virtual meeting; and sending the first join link to the user device.

In accordance with still another embodiment, a computer-implemented method is provided including: for each of a plurality of previously scheduled virtual meetings, generating a first join link and a second join link, the second join link being generated based on a meeting calendar identifier associated with a corresponding scheduled virtual meeting and having more characters than the first join link; storing the first join link and the second join link for each of the plurality of previously scheduled virtual meetings, including information mapping the first join link to the second join link for each associated scheduled virtual meeting; receiving a communication from a user device using a particular first join link to join a particular scheduled virtual meeting; retrieving a particular second join link that is mapped to the particular first join link; and using the particular second join link, connecting the user device to a meeting service that supports the particular scheduled virtual meeting.

### Example Embodiments

According to the embodiments presented herein, the scheduling of a virtual meeting (video conference, web conference, audio conference, or any other conference technology now known or hereinafter developed) is simplified to “people scheduling people.” The meeting organizer need only schedule the meeting participants and a physical shared meeting room which may include a video conference endpoint, and not the meeting resources/services. The meeting participants can join the conference with any equipment they choose. This is not possible with current technology.

The apparatus, system, and methods presented herein allow virtual meetings to be scheduled without having to distribute additional information about the meeting resources/services to be used for the meeting. The calendar/scheduling function (responsible for when the meeting is to occur and who will participate in the meeting) is separated from the virtual conferencing domain (responsible for allowing participants to join and connect to the virtual meeting). In other words, a meeting participant can join any meeting using any equipment he/she chooses at the time of joining the meeting without the meeting organizer having to specify or schedule the meeting resource technology for the scheduled meeting.

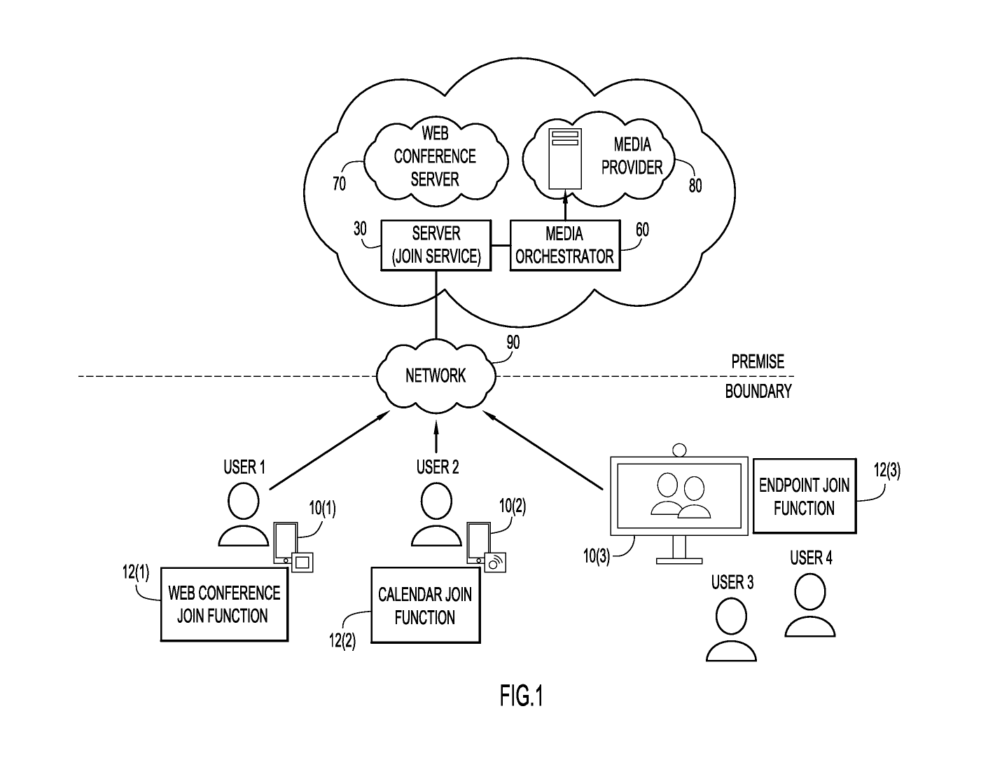

Referring first to FIG. 1, a diagram is shown of an environment in which the apparatus, system, and methods presented herein may be deployed. At a high level, the system includes a join link client function that is provided at a calendar application on a user device. This join link client function may be embodied as plug-in software to a calendar application or may be a function integrated into the calendar application software.

FIG. 1 shows an example in which there are multiple user devices 10(1), 10(2), 10(3), each running a calendar application of some type, and associated with each calendar application there is a join link client function. The calendar application may be a stand-alone function on a user device or may be integrated into, or interfaced with, another application, such as a web conference application. The user devices can take on a variety of forms, including a SmartPhone, tablet, laptop computer, desktop computer, conference endpoint etc. User device 10(1) runs web conference client software and has associated therewith a web conference join function 12(1). Similarly, user device 10(2) runs a calendar application and has a calendar join function 12(2). Likewise, user device 10(3) is a video conference endpoint and has an endpoint join function 12(3).

The user devices may communicate with a server 30. The server 30 provides a join service that is brought into play at the time that a user clicks on a join link order to join the virtual meeting. The server 30 is also involved in the generation of a human readable join link. The server 30 can host the meeting itself, or function as a proxy and forward requests to a virtual meeting hosting service, as will be described hereinafter.

FIG. 1 also shows that the user devices may be physical locally on premises (OP) of an enterprise or other organization, though this is not required. In addition, FIG. 1 shows that the server 30, along with a media orchestrator function 60, web conference server 70 and media provider 80 may reside off premises in a cloud or data center computing environment. This is not meant to be limiting as the server 30 may reside on premises. The media orchestrator 60 ensures that all the participants get connected to the same meeting being supported by the media provider 80, or in the case of multiple media providers, to the appropriate one or more media providers. The functions of the media orchestrator 60 and/or the media provider(s) 80 may be performed by separate entities as shown, or may be integrated into the functions performed by the server 30 (either on-premises, in the cloud, or a hybrid of on-premises and cloud). The user device 10 communicates with server 30 via a network 90. Network 90 may be any one or more of a wired or wireless local area network (LAN) and wired or wireless wide area network. The network 90 may support a variety of protocols, including without limitations, Session Initiation Protocol (SIP), Hypertext Transfer Protocol (HTTP), Real-time Transport Protocol (RTP), Hypertext Transfer Protocol Secure (HTTPS), etc.

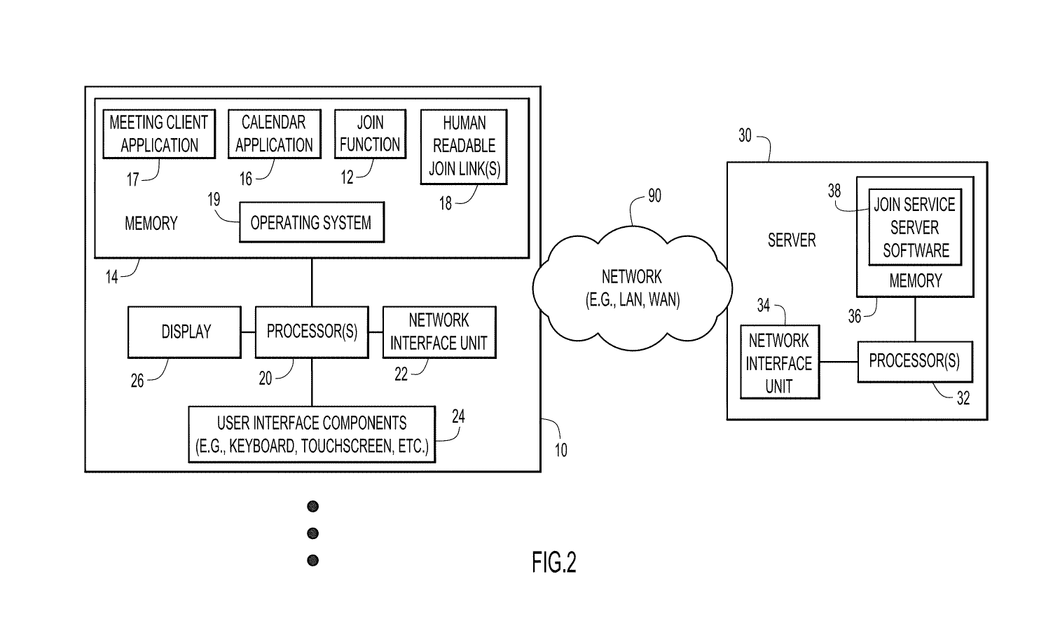

Reference is now made to FIG. 2. FIG. 2 shows a block diagram of a user device 10 having a join function 12, and server 30. The user device 10 and server 30 are in communication with each other via network 90.

The user device 10 may include a memory 14 storing the software instructions for the join function 12, along with software instructions for a calendar application 16, a meeting client application 17 (e.g., web conference client application, endpoint client application, etc., that uses, interfaces or has integrated therein functions of the calendar application), and one or more human readable join links 18 obtained from the server 30 as described hereinafter. For the sake of completeness, FIG. 2 also shows an operating system 19 on which the application 16 and the join link 12 run. The user device 10 further includes a processor 20 (e.g., a microprocessor or microcontroller), a network interface unit 22 that enables wired and/or wireless network communication, one or more user interface components 24 (e.g., keyboard, mouse, touchscreen, etc.) and a display screen/monitor 26. Other user devices may have a similar block diagram representation as that shown for user device 10 shown in FIG. 2.

The server 30 includes one or more processors 32, a network interface unit 34 and a memory 36. The memory 36 stores instructions for join service server software 38.

The memory 14 and memory 36 shown in FIG. 2 may include read only memory (ROM), random access memory (RAM), magnetic disk storage media devices, optical storage media devices, flash memory devices, electrical, optical, or other physical/tangible memory storage devices. Thus, in general, the memory shown in FIG. 2 may include one or more tangible (non-transitory) computer readable storage media (e.g., a memory device) encoded with software comprising computer executable instructions and when the software is executed (by the associated processor) the processor is operable or caused to perform the operations described herein, for the user device 10 and server 30.

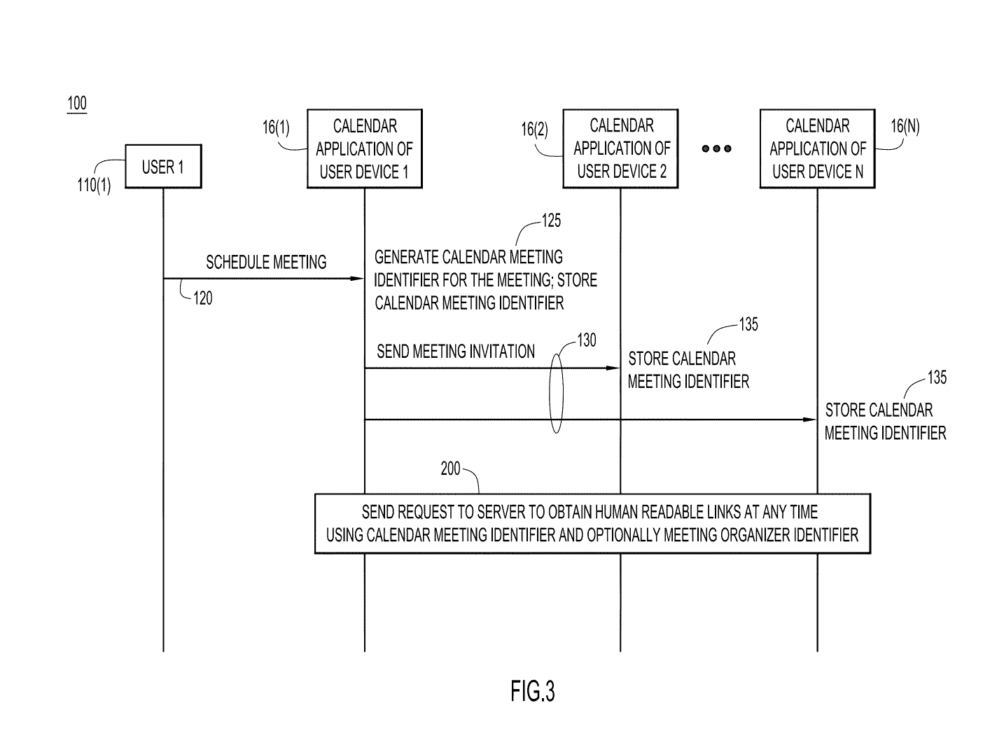

Reference is now made to FIG. 3. FIG. 3 illustrates a process flow 100 when a user schedules a meeting. In this example, User 1 shown at reference numeral 110(1) schedules a meeting to which User 2-User N are invited to participate. On the user device of User 1 (User Device 1), there is a calendar application shown at reference numeral 16(1), and similarly User Device 2 has a calendar application 16(2) and User Device N has a calendar application 16(N). The calendar applications 16(1)-16(N) are capable of generating a meeting (generating a meeting appointment) and sending a meeting invitation to users, as well as receiving a meeting invitation. It should be understood that the functions of the calendar applications 16(1)-16(N) may be integrated as part of a meeting client application, as explained above.

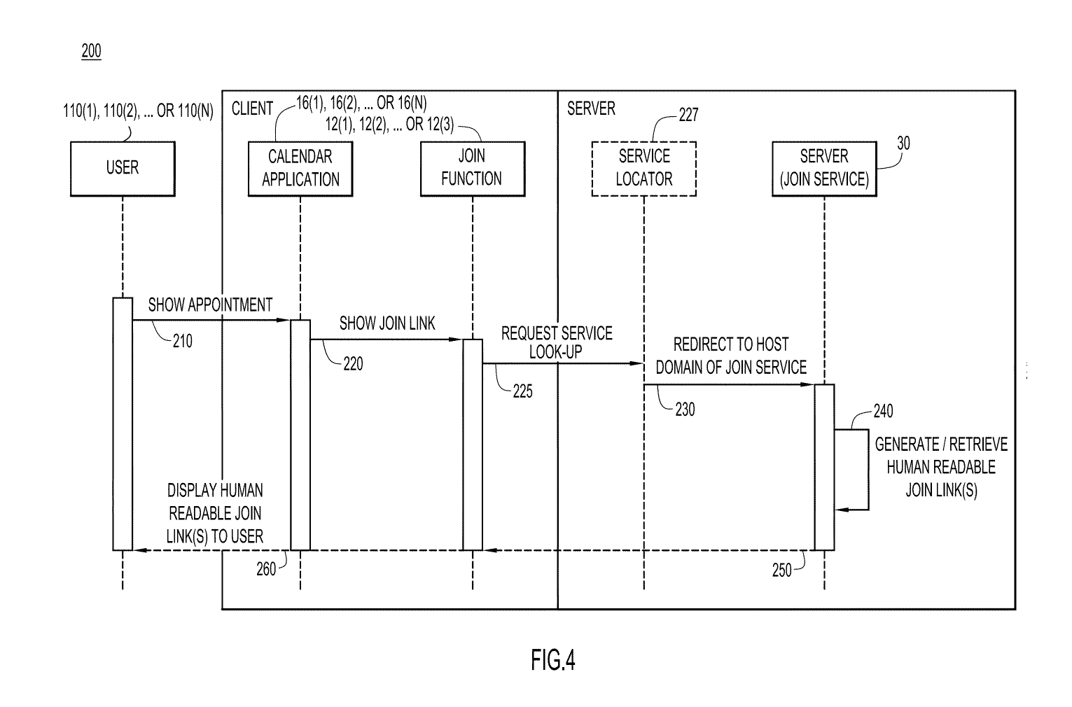

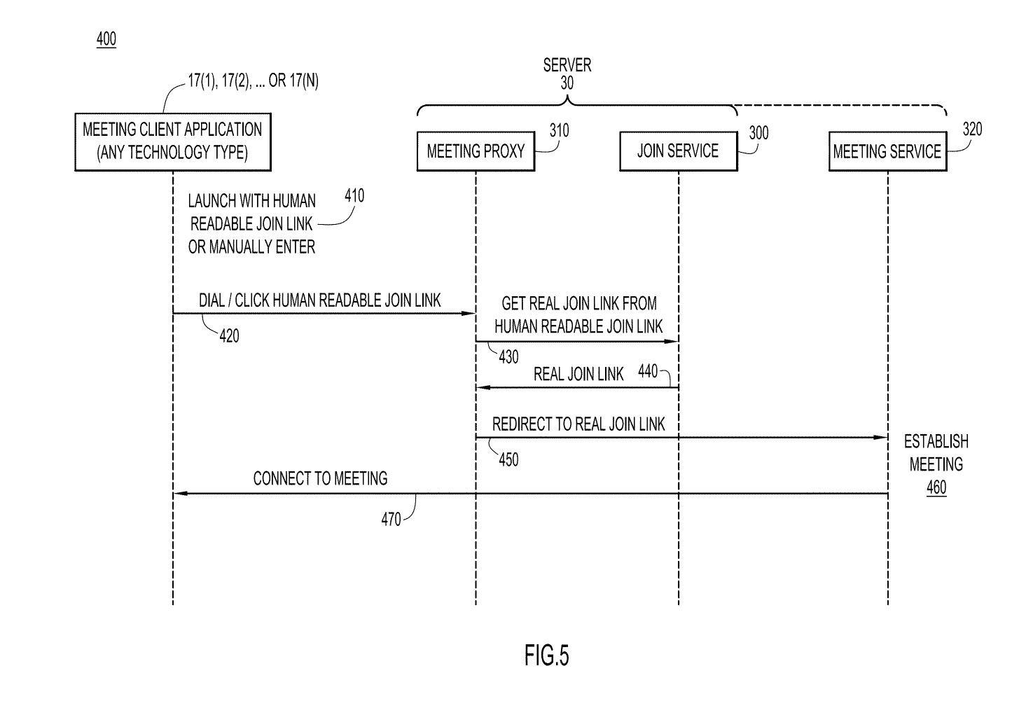

At 120, User 1 uses calendar application 16(1) to schedule a virtual meeting at a given date and time in the future, and the participants of the meeting are User 2-User N. At 125, the application 16(1) generates a calendar meeting identifier for the scheduled meeting, and stores the calendar meeting identifier. At 130, the calendar application 16(1) causes a meeting invitation to be sent to the user devices for User 2-User N. At 135, if User 2-User N accepts the invitation, the calendar applications 16(2)-16(N) will each store the calendar meeting identifier (and the meeting organizer identifier). From this point forward, as shown at reference numeral 200, the user devices for User 1-User N can communicate with the server 30 at any time to request a human readable join link using the calendar meeting identifier and optionally the meeting organizer identifier for the scheduled virtual meeting. The process 200 for obtaining the human readable join link is described below in connection with FIGS. 4 and 5.

The meeting calendar identifier may be any identifier that is unique to the scheduled meeting. In one example, the calendar (or other similar) application that is used to schedule a meeting generates the meeting calendar identifier that is compliant with the Internet Calendaring and Scheduling Core Object Specification (iCalendar) of RFC 5545, or any other suitable format that is common or compatible with applications running across user devices.

The iCalendar (iCal) object generated for a meeting includes a universal identifier (UID), and this UID may be used as the meeting calendar identifier. An example format of an iCalendar object is provided in RFC 5545, and example format of the UID is: 19970610T172345Z-AF23B2@example.com. The iCal UID is an identifier that is distributed to all participants of a meeting in an iCal-based calendaring system (Microsoft Exchange, Office 365, Gmail, etc.). This identifier connects participant invitations, responses to a single meeting and is identical for all meeting invitees in addition to the organizer. The meeting organizer identifier may be an email address of the user that organizes (hosts) the meeting, e.g., user1@company.com.

A method is presented herein for reading the meeting identifier (e.g., iCal UID) and the organizer e-mail for a scheduled meeting, and connecting to a service (the server 30) to produce a human readable (shorter) representation of a join link/dial-string as one or more clickable Universal Resource Identifier(s) (URIs). The human readable join link allows for interaction with user devices that do not need to have any special software capabilities. This shorter representation of the join link is easily human readable so that it can be read and manually typed in, if necessary. For example, a clickable URL is useful to direct a web browser client running on a user device to the server 30 in the cloud. Similarly, a simplified SIP URI is useful to be manually dialed by a user device running an application that uses SIP to join a meeting.

Reference is now made to FIG. 4, which shows a flow for a process 200 by which a human readable join link is obtained by a user device, according to an example embodiment. The process 200 can be performed by a meeting organizer or any meeting participant/invitee at any time after a virtual meeting has been scheduled. It is assumed that a virtual meeting has already been scheduled by a meeting organizer and the meeting organizer identifier and meeting calendar identifier (e.g., iCal UID) are known for that meeting. At 210, a user initiates an operation with a calendar application running on his/her device to show an appointment for a scheduled meeting. At 220, the calendar application generates a request for a join link.

At 225, the join function of that user device takes the meeting calendar identifier (e.g., iCal UID), and optionally the meeting organizer identifier for the meeting associated with the scheduled virtual meeting and sends a join link request (containing at least the meeting calendar identifier for the scheduled virtual meeting) to a service locator function 227. The service locator function 227 may reside on the client (as part of or separate of the join function), on the server 30, or at both the client side and the server side. If the client side is simplistic and has only one server address to call, then the service locator function 227 can reside on the server side. If there is a redirection to a domain of the server 30, then there can be service locator functions on both the client side and server side. The service locator function 227 performs a lookup to locate the domain of the join service (server 30) to handle the request from the join function. The service locator function 227 obtains the host domain of the join service (server 30) and at 230 directs the request for the human readable join link to the server 30. The service locator function 227 is optional because if the host domain of the server 30 (join service) is static, the service locator function 227 is not needed.

The service locator function 227 may operate by checking the Domain Name Service (DNS) for a Service record (SRV record) for the join service at the organizer domain which gives the hostname of the join service. This is performed before the service locator function 227 forwards the request, at 230, for the human readable join link to that domain. For example, an SRV record lookup is made for conference.tcp<org domain>, where _conference_{—} is the name used for the join service, as an example. A SIP record_conference.tcp<org domain> points to the service hostname either inside or external to the organizer domain. If the organizer domain is a subdomain (e.g., users.enterprise.com), then an attempt is made with the top-level domain (enterprise.com) of the meeting organizer Otherwise, if no service records are to be found, a fallback to a global static host domain (e.g., join-service.com) is used.

At 240, the server 30 generates or retrieves a human readable join link for the meeting, and at 250, the server sends the human readable join link back to the user device where it can be displayed to the user at 260. More specifically, at 240, the server 30 generates a “real” join link that is used by the server, when a user device requests to join the virtual meeting, to connect the user device into the virtual meeting. The server 30 generates this real join link based on the meeting calendar identifier (and optionally the meeting organizer identifier). The server 30 also generates, when requested to do so by a user device, a human readable join link that serves as a place holder for and corresponds to the real join link for a given virtual meeting. Thus, for any given scheduled virtual meeting, the server 30 will generate a first link and a second join link that are mapped to or associated with each other. The first join link is the aforementioned “human readable” join link and the second join link is the real join link. The second link has more characters than the first join link, and as explained above, the first join link has a human readable portion that includes a random or non-random string of characters. The server 30 stores a mapping between human readable join links and associated real join links for each scheduled virtual meeting that it has knowledge of.

Once the human readable join link is received by the user device, it is stored and can thereafter be retrieved to join a meeting, or can be manually entered by that user or any user to join a meeting. Moreover, it is possible that the meeting organizer invokes process 200 in order to obtain the human readable join link for a meeting and sends it in a meeting invite to each of the participants of a meeting that the meeting organizer has scheduled.

At 240, the server 30 uses the meeting calendar identifier (e.g., UID) and optionally the meeting organizer identifier and checks if there already exists a human readable join link for that meeting. If a human readable join link already exists, then the server 30 responds with that human readable join link. If a human readable join link does not already exist for that meeting, then the server 30 generates it.

One technique to generate the human readable join link is as follows:

Host of join service: A
Human Readable Portion B: n random characters [a-z,0-9]
C: action identifier (join action) (optional)
Combine this into a join URL, https://A/C/B, such as:

https://example.com/r/2f92ap8

https://example.com/2f92ap8

In the SIP domain, the join URI is SIP:B@A. An example would be:

sip:2f92ap8@example.com

In the above examples, the use of random characters is not meant to be limiting. The human readable portion of the join link (the n random or non-random characters) is the same across different protocols, e.g., HTTP and SIP, as illustrated in the example above. Moreover, the human readable join link can be generated by any user associated with a scheduled virtual meeting (e.g., meeting organizer or meeting invitee/participant) at any time after the meeting invitation is created and sent. All users associated with the same meeting will get the same human readable join link(s).

In general, the human readable meeting join link (and its “real” join link counterpart) is a URI of any URI scheme including, but not limited to, a URI with a scheme for the Session Initiation Protocol (SIP), a URI with a scheme for the Hypertext Transport Protocol (HTTP), and a URI with a scheme for the Hypertext Transfer Protocol Secure (HTTPS), etc.

Furthermore, at operation 240 in FIG. 4, the server 30 may generate (or retrieve if already generated) multiple human join links for the same (any given) scheduled virtual meeting. Each of the multiple human readable join links for a given virtual meeting may be for a different type of protocol, e.g., a first human readable join link for SIP, a second human readable join link for HTTP, a third human readable join link for HTTPS, etc. For example, server 30 may generate 3 links (URIs) for a given scheduled virtual meeting:

1. One URI for the SIP scheme: sip:2f92ap8@example.com

2. A second URI for the HTTP scheme: http://example.com/2f92ap8

3. A third URI for an unknown (future to be determined) scheme: xx:2f92ap8

where “2f92ap8” is the human readable portion as referred to above which was generated by the server at the first request for a human readable join link. This Human Readable Portion may be the same across all URI schemes and will in any case serve as the placeholder for the real join link in the given URI scheme. Thus, when generating a human readable meeting join link for a scheduled virtual meeting, the server may generate a plurality of human readable meeting join links, each of the plurality of human readable meeting join links associated with the scheduled virtual meeting. Moreover, each of the plurality of human readable meeting join links is for a different communication protocol by which the scheduled virtual meeting can be joined. It is to be understood that for each human readable meeting join link of each of the different protocol types, the server 30 also generates a “real” join link of each of the different protocol types.

As shown at 250 in FIG. 4, the server 30 sends the human readable join link(s) to the calendar application running on the user device.

The one or more human readable join links (e.g., URIs) generated need not have to dictate any specific meeting service/technology, and the meeting service can be changed until the time that the meeting is started without burdening the meeting organizer with having to redistribute URIs for new/different meeting technology. The human readable join link serves as a “placeholder” for the actual join link to connect to the virtual meeting, as described further below.

Reference is now made to FIG. 5. FIG. 5 illustrates a flow for a process 400 performed when a user seeks to join a meeting using a human readable join link. This process involves interaction between a meeting client application running on a user device, a join service 300, a meeting proxy 310 and a meeting service 320. The join service 300 is a process running on the server 30 that maintains a mapping of human readable join links to corresponding real join links for a given virtual meeting, as described above in connection with FIG. 4. The meeting proxy 310 could be a process internal to the server 30. If the server 30 has all the media processing (media orchestrator logic), then a redirect by the meeting proxy 310 is not needed, and the server 30 will terminate the call/session for connecting a user device to a virtual meeting. The meeting proxy 310 allows for redirection to other services when the media resources are separate from or external to the server 30. Thus, the meeting service 320 may be a function of the server 30 or external to the server 30, as indicated by the dashed line in FIG. 5.

At 410, a user launches meeting client application with a human readable join link, or manually enters it, for a meeting. At 420, the meeting client application dials the human readable join link, resulting in it connecting to the meeting proxy function 310. At 430, the meeting proxy 310 sends a request to the join service 300 to get the real join link that corresponds to the human readable join link. At 440, the join service 300 returns the real join link for that meeting to the meeting proxy 310. At 450, the meeting proxy 310 redirects to the meeting service 320 based on the real join link. Again, the redirection by the meeting proxy 310 may not be necessary if the meeting service 320 is running on the server 30. At 460, the meeting service 320 establishes the meeting. At 470, the meeting service connects the meeting client application to the meeting.

To summarize the operations of FIG. 5, when the scheduled meeting starts according to the calendar entry on the meeting organizer's device or any of the meeting participants' devices, the meeting client application will present the human readable join link(s). When the human readable join link(s) is activated (clicked or dialed), the meeting proxy for the protocol in use (e.g., SIP or HTTP) will check if the meeting is active and redirect to the virtual meeting. If the virtual meeting has not been started, the meeting service 320 will create the meeting.

If the meeting service 320 hosting the meeting is external to the server 30, it can notify the server 30 that a meeting has ended (when all participants have left), and the server 30 can be configured to not forward subsequent join requests to the (old) virtual meeting, but rather create a new virtual meeting, if necessary. In addition, the server 30 could allow commands (web service, Representational State Transfer (REST), etc.) to set up/start a virtual meeting so it is ready when the first person joins. For example, the human readable join link https://join-service.com/j/AB34SD will forward the user to https://otalpha.webconferenceserver.com/otalpha/j.php?J=123456789. Similarly, the human readable join link sip:AB34SE@join-service.com will hide the meeting technology selection and forward the user to the technology-bound address at join time: sip:organizerid@cmralpha.webconferenceserver.com.

In summary, presented above are techniques for the generation and use of human-readable meeting technology-agnostic join links (dial strings) based on a meeting invitation for which the original meeting organizer is maintained. The creation/request of the human readable join link may be initiated by meeting participants or a meeting owner.

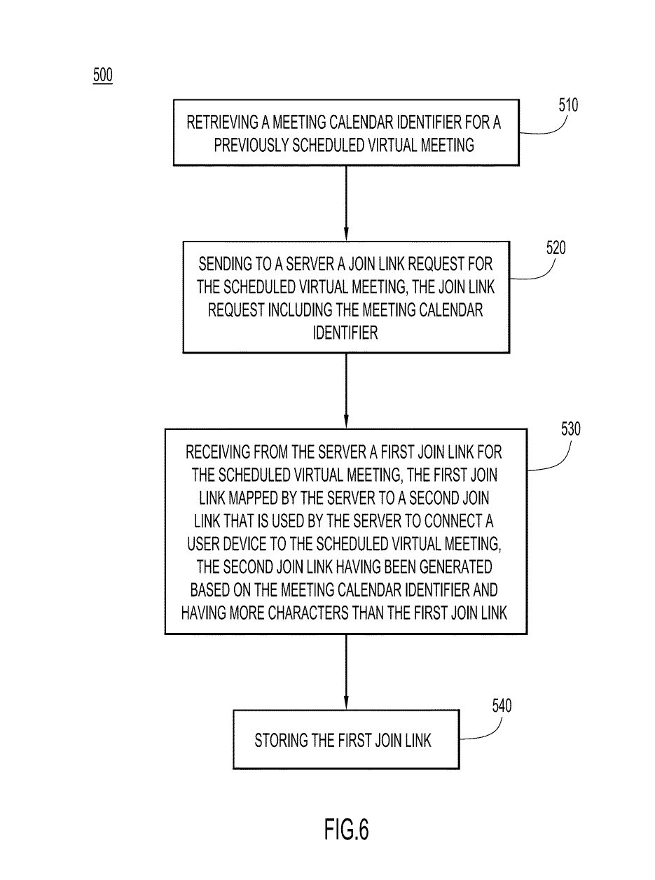

Reference is now made to FIG. 6. FIG. 6 illustrates a flow chart depicting operations of a method 500 performed in a user device according to an example embodiment. The method 500 is performed in a user device that is capable of scheduling a meeting with a calendar application or receiving an invitation to a meeting. At 510, the user device retrieves a meeting calendar identifier for a previously scheduled virtual meeting. In other words, the virtual meeting has already been scheduled, either by this user device or another user device. At 520, the user device sends to a server (e.g., server 30 shown in FIG. 1) a join link request for the scheduled virtual meeting. At 530, the user devices receives from the server a first join link for the scheduled virtual meeting, the first join link mapped by the server to a second join link that is used by the server to connect a user device to the scheduled virtual meeting, the second join link having been generated based on the meeting calendar identifier and having more characters than the first join link. At 540, the user device stores the first join link. As explained above, multiple first join links may be generated for a given scheduled virtual meeting and the user device may therefore receive multiple first join links, each for a different communication protocol (e.g., SIP, HTTP, HTTPS, etc.).

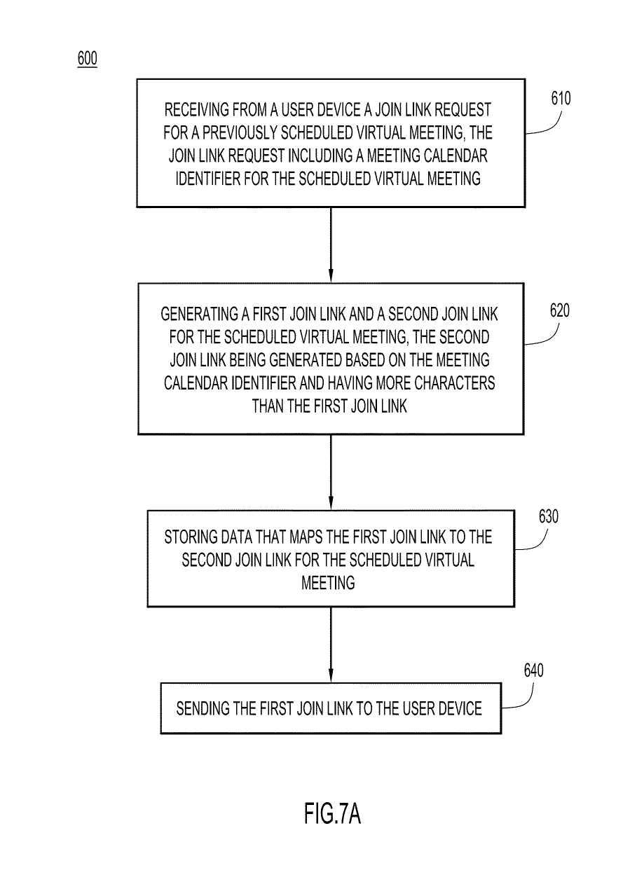

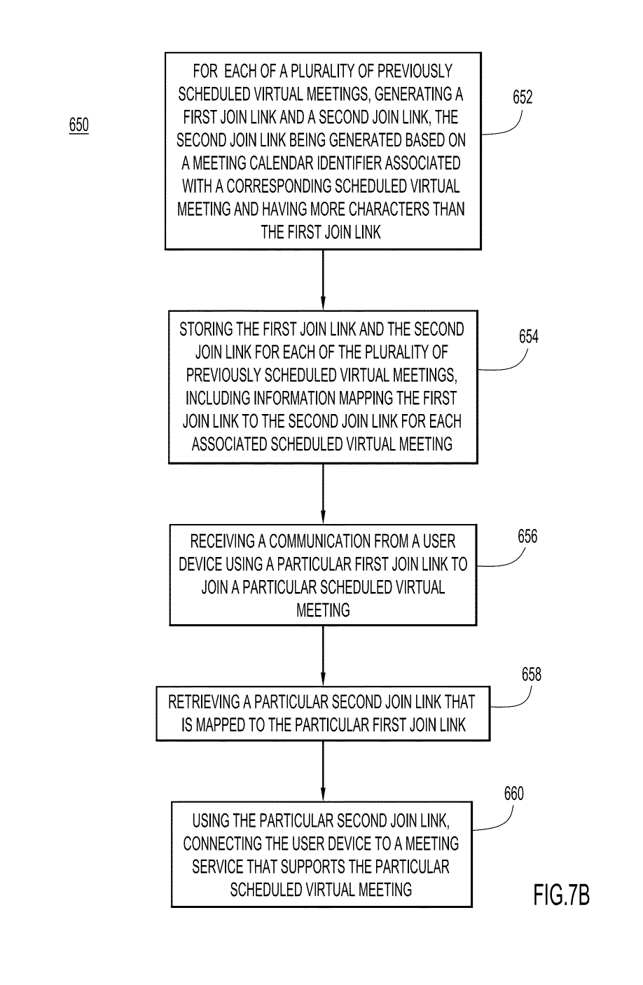

Turning now to FIG. 7A, a flow chart is shown for operations of a method 600 performed by a server, e.g., server 30, according to an example embodiment. Method 600 involves operations of the server in generated (or retrieving) first join links and sending them to a user device for a given previously scheduled virtual meeting. At 610, the server receives from a user device a join link request for a previously scheduled virtual meeting, the join link request including a meeting calendar identifier for the scheduled virtual meeting. At 620, the server generates a first join link and a second join link for the scheduled virtual meeting, the second join link being generated based on the meeting calendar identifier and having more characters than the first join link. As explained above, the server need only perform this generating step one time for the first join link request from a user device. The next time the server receives a join link request for that same scheduled virtual meeting, the server can retrieve the previously generated first join link. At 630, the server stores data that maps (associates) the first join link to the second join link for the scheduled virtual meeting. This operation is done so that the server can retrieve the second join link (real join link) for a scheduled virtual meeting when it receives a communication from a user device to join a virtual meeting with a first join link. At 640, the server sends the first join link to the user device.

FIG. 7B illustrates a flow chart for operations of a method 650 performed by the server in connection with joining a user device to a previously scheduled virtual meeting. At 652, the server generates, for each of a plurality of previously scheduled virtual meetings, a first join link and a second join link, the second join link being generated based on a meeting calendar identifier associated with a corresponding scheduled virtual meeting and having more characters than the first join link. At 654, the server stores the first join link and the second join link for each of the plurality of previously scheduled virtual meetings, including information mapping the first join link to the second join link for each associated scheduled virtual meeting. At 656, the server receives a communication from a user device using a particular first join link to join a particular scheduled virtual meeting. At 658, the server retrieves a particular second join link that is mapped to the particular first join link. At 660, using the particular second join link, the server connects the user device to a meeting service that supports the particular scheduled virtual meeting.

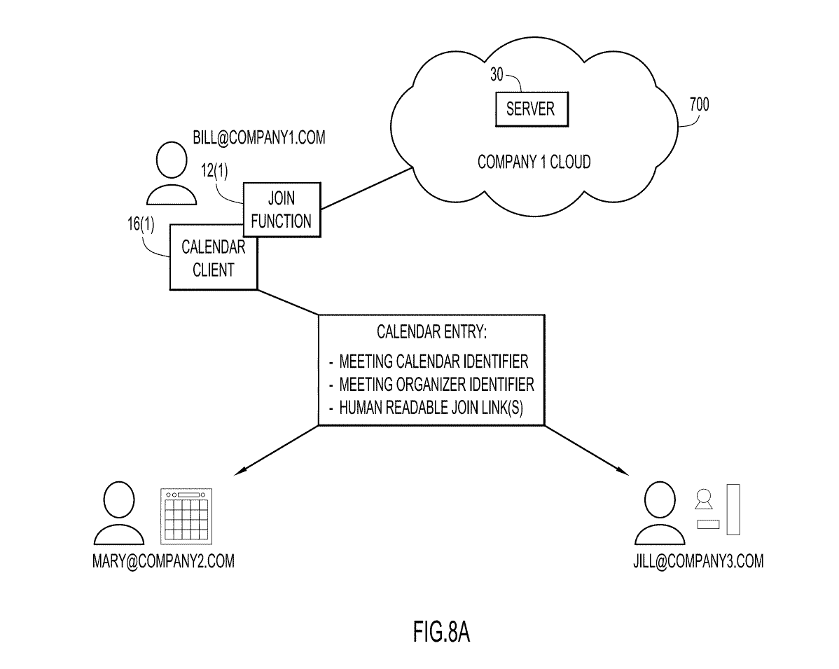

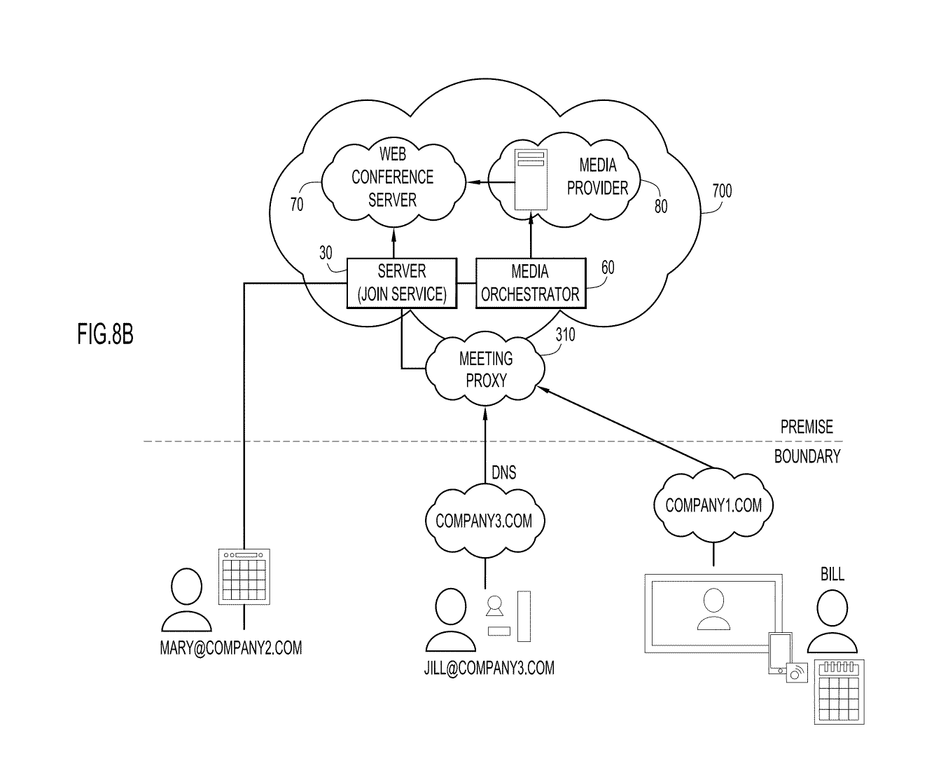

Reference is now made to FIGS. 8A and 8B for a description of a real-world example of the techniques presented above. Referring first to FIG. 8A, Bill is an employee of Company 1 and has an email address Bill@company1.com. Bill schedules a meeting with his calendar application 16(1) and the join function 12(1) on his device communicates with the server 30 in a cloud/data center for Company 1, shown at reference numeral 700. The server 30 returns one or more human readable join links to Bill's device, and the calendar application 16(1) generates a calendar entry for the meeting. The calendar entry includes the meeting calendar identifier, meeting organizer identifier, and the one or more human readable join links for the meeting. Bill ends the meeting invitation to Mary at Company 2 and Jill at Company 3. The human readable join link(s) may include a clickable URL to the server 30 in the cloud 700 or a simplified SIP URI that can be manually dialed by SIP user devices.

Reference is now made to FIG. 8B. At this point, Bill, Mary and Jill each have the human readable join link(s) for the meeting that Bill scheduled. Mary clicks on a URL that directs her to the server 30 via meeting proxy 310, which in turn connects Mary to a web conference meeting that the server 30 created. Bill and Jill click on the URL as well, which resolves them to the cloud 700 using Domain Name System (DNS), via meeting proxy 310. The server 30 identifies the origin of the meeting from the real join link to which the URL is mapped to further identify the tenant's media resources. The media orchestrator 60 can facilitate cloud or on-premises hosting of the meeting.

Thus, in summary, presented herein are techniques for deferred creation of a human-readable meeting-technology-agnostic join links strings based on a meeting invitation for which the original meeting owner/organizer is maintained. The creation/request of the human-readable/short join link may be initiated by meeting participants or a meeting owner/organizer.

In one form, a method is provided comprising: a computer-implemented method is provided. In a user device capable of scheduling a meeting with a calendar application or receiving an invitation to a meeting, operations are performed comprising: retrieving a meeting calendar identifier for a previously scheduled virtual meeting; sending to a server a join link request for the scheduled virtual meeting, the join link request including the meeting calendar identifier; receiving from the server a first join link for the scheduled virtual meeting, the first join link mapped by the server to a second join link that is used by the server to connect a user device to the scheduled virtual meeting, the second join link having been generated based on the meeting calendar identifier and having more characters than the first join link; and storing the first join link.

In another form, a computer-implemented method is provided comprising: receiving from a user device a join link request for a previously scheduled virtual meeting, the join link request including a meeting calendar identifier for the scheduled virtual meeting; generating a first join link and a second join link for the scheduled virtual meeting, the second join link being generated based on the meeting calendar identifier and having more characters than the first join link; storing data that maps the first join link to the second join link for the scheduled virtual meeting; and sending the first join link to the user device.

In still another form, a computer-implemented method is provided comprising: for each of a plurality of previously scheduled virtual meetings, generating a first join link and a second join link, the second join link being generated based on a meeting calendar identifier associated with a corresponding scheduled virtual meeting and having more characters than the first join link; storing the first join link and the second join link for each of the plurality of previously scheduled virtual meetings, including information mapping the first join link to the second join link for each associated scheduled virtual meeting; receiving a communication from a user device using a particular first join link to join a particular scheduled virtual meeting; retrieving a particular second join link that is mapped to the particular first join link; and using the particular second join link, connecting the user device to a meeting service that supports the particular scheduled virtual meeting.

In still another form, an apparatus is provided comprising: a network interface unit configured for communications over a network; a memory; a processor coupled to the network interface and the memory, wherein the processor is configured to: receive from a user device a join link request for a previously scheduled virtual meeting, the join link request including a meeting calendar identifier for the scheduled virtual meeting; generate a first join link and a second join link for the scheduled virtual meeting, the second join link being generated based on the meeting calendar identifier and having more characters than the first join link; and store in the memory data that maps the first join link to the second join link for the scheduled virtual meeting.

In still another form, one or more tangible (non-transitory) computer readable storage media are provided that are encoded with instructions that, when executed by a computer processor, cause the computer processor to: in a user device capable of scheduling a meeting with a calendar application or receiving an invitation to a meeting: retrieve a meeting calendar identifier for a previously scheduled virtual meeting; send to a server a join link request for the scheduled virtual meeting, the join link request including the meeting calendar identifier; receive from the server a first join link for the scheduled virtual meeting, the first join link mapped by the server to a second join link that is used by the server to connect a user device to the scheduled virtual meeting, the second join link having been generated based on the meeting calendar identifier and having more characters than the first join link; and store the first join link.

In yet another form, one or more tangible (non-transitory) computer readable storage media are provided that are encoded with instructions that, when executed by a computer processor, cause the computer processor to: receive from a user device a join link request for a previously scheduled virtual meeting, the join link request including a meeting calendar identifier for the scheduled virtual meeting; generate a first join link and a second join link for the scheduled virtual meeting, the second join link being generated based on the meeting calendar identifier and having more characters than the first join link; store data that maps the first join link to the second join link for the scheduled virtual meeting; and send the first join link to the user device.

In still another form, one or more tangible (non-transitory) computer readable storage media are provided that are encoded with instructions that, when executed by a computer processor, cause the computer processor to: for each of a plurality of previously scheduled virtual meetings, generate a first join link and a second join link, the second join link being generated based on a meeting calendar identifier associated with a corresponding scheduled virtual meeting and having more characters than the first join link; storing the first join link and the second join link for each of the plurality of previously scheduled virtual meetings, including information mapping the first join link to the second join link for each associated scheduled virtual meeting; receive a communication from a user device using a particular first join link to join a particular scheduled virtual meeting; retrieve a particular second join link that is mapped to the particular first join link; and using the particular second join link, connect the user device to a meeting service that supports the particular scheduled virtual meeting.

Although the techniques are illustrated and described herein as embodied in one or more specific examples, it is nevertheless not intended to be limited to the details shown, since various modifications and structural changes may be made within the scope and range of equivalents of the claims.

What is claimed is:

1. A computer-implemented method comprising:
in a user device capable of scheduling a meeting with a calendar application or receiving an invitation to a meeting:
retrieving a meeting calendar identifier for a previously scheduled virtual meeting;
sending to a server a join link request for the scheduled virtual meeting, the join link request including the meeting calendar identifier;
receiving from the server a first join link for the scheduled virtual meeting, the first join link mapped by the server to a second join link that is used by the server to connect a user device to the scheduled virtual meeting, the second join link having been generated based on the meeting calendar identifier and having more characters than the first join link; and
storing the first join link.

2. The method of claim 1, wherein the first join link is a Uniform Resource Identifier (URI) of any URI scheme.

3. The method of claim 2, wherein the first join link is a URI with a scheme for the Session Initiation Protocol (SIP).

4. The method of claim 2, wherein the meeting join link is a URI with a scheme for the Hypertext Transport Protocol (HTTP).

5. The method of claim 2, wherein the meeting join link is a URI with a scheme for the Hypertext Transport Protocol Secure (HTTPS).

6. The method of claim 1, wherein the meeting calendar identifier is an identifier compliant with the iCalendar standard of RFC 5545.

7. The method of claim 1, further comprising:
activating the first join link to connect to a server which uses the second join link corresponding to the first join link to connect the user device to the schedule virtual meeting.

8. The method of claim 1, wherein the first join link includes a human readable portion that includes a random or non-random string of characters.

9. The method of claim 1, wherein receiving comprises receiving a plurality of first join links, each associated with the scheduled virtual meeting, each of the plurality of meeting join links for a different communication protocol by which the scheduled virtual meeting may be joined.

10. A computer-implemented method comprising:
receiving from a user device a join link request for a previously scheduled virtual meeting, the join link request including a meeting calendar identifier for the scheduled virtual meeting;
generating a first join link and a second join link for the scheduled virtual meeting, the second join link being generated based on the meeting calendar identifier and having more characters than the first join link;
storing data that maps the first join link to the second join link for the scheduled virtual meeting; and
sending the first join link to the user device.

11. The method of claim 10, wherein receiving comprises receiving a meeting organizer identifier for the scheduled virtual meeting, and wherein generating comprises generating the second join link based further on a meeting organizer identifier for the scheduled virtual meeting.

12. The method of claim 10, wherein the first join link is a Uniform Resource Identifier (URI) of any URI scheme.

13. The method of claim 10, wherein the meeting calendar identifier is an identifier compliant with the iCalendar standard of RFC 5545.

14. The method of claim 10, wherein the first join link includes a human readable portion that includes a random or non-random string of characters.

15. The method of claim 10, further comprising:
receiving from another user device a join link request for the scheduled virtual meeting;
determining that the first join link for the scheduled virtual meeting has already been generated;
sending the first join link for the scheduled virtual meeting to the other user device.

16. The method of claim 8, wherein generating comprises generating a plurality of first join links each associated with the scheduled virtual meeting, each of the plurality of first meeting join links for a different communication protocol by which the scheduled virtual meeting may be joined.

17. A computer-implemented method comprising:
for each of a plurality of previously scheduled virtual meetings, generating a first join link and a second join link, the second join link being generated based on a meeting calendar identifier associated with a corresponding scheduled virtual meeting and having more characters than the first join link;
storing the first join link and the second join link for each of the plurality of previously scheduled virtual meetings, including information mapping the first join link to the second join link for each associated scheduled virtual meeting;
receiving a communication from a user device using a particular first join link to join a particular scheduled virtual meeting;
retrieving a particular second join link that is mapped to the particular first join link; and
using the particular second join link, connecting the user device to a meeting service that supports the particular scheduled virtual meeting.

18. The method of claim 17, wherein the first join link is a Uniform Resource Identifier (URI) of any URI scheme.

19. The method of claim 17, wherein generating comprises generating a plurality of first join links for a given scheduled virtual meeting, each of the plurality of first meeting join links for a different communication protocol by which the given scheduled virtual meeting may be joined.

20. The method of claim 19, further comprising receiving communications from multiple user devices each using a first join link for a different communication protocol for a given scheduled virtual meeting, and connecting the multiple user devices joining with first join links for different communication protocols into the same virtual meeting.

21. An apparatus comprising:
a network interface unit configured for communications over a network;
a memory;
a processor coupled to the network interface and the memory, wherein the processor is configured to:
receive from a user device a join link request for a previously scheduled virtual meeting, the join link request including a meeting calendar identifier for the scheduled virtual meeting;
generate a first join link and a second join link for the scheduled virtual meeting, the second join link being generated based on the meeting calendar identifier and having more characters than the first join link; and
store in the memory data that maps the first join link to the second join link for the scheduled virtual meeting.

22. The apparatus of claim 21, wherein the processor is further configured to send the first join link to the user device.

23. The apparatus of claim 21, wherein the first join link includes a human readable portion that includes a random or non-random string of characters.

24. The apparatus of claim 21, wherein the processor is further configured to:
receive from another user device a join link request for the scheduled virtual meeting;
determine that the first join link for the scheduled virtual meeting has already been generated; and
send the first join link for the scheduled virtual meeting to the other user device.

25. The apparatus of claim 21, wherein the processor is configured to generate a plurality of first join links each associated with the scheduled virtual meeting, each of the plurality of first meeting join links for a different communication protocol by which the scheduled virtual meeting may be joined.
